(19) United States
(12) Patent Application Publication
(10) Pub. No.: US 2015/0316251 A1
(43) Pub. Date: Nov. 5, 2015

(54) Knuckle Lights

(71) Applicant: Harvey Gonzales Carrathus, Beaumont, CA (US)

(72) Inventor: Harvey Gonzales Carrathus, Beaumont, CA (US)

(21) Appl. No.: 14/306,083

(22) Filed: Jun. 16, 2014

Related U.S. Application Data
(60) Provisional application No. 61/988,152, filed on May 3, 2014.

(51) Int. Cl. F21V 33/00; F21V 23/04; A41D 19/00

(52) U.S. Cl. CPC F21V 33/0008; A41D 19/0031; F21V 23/04

(57) ABSTRACT

1. A utility device that can be worn in the same manner as gloves simultaneously on both hands consisting of a power supply that sends an alternating current to an iridescent LED series of 5 mm lights connected to a battery power source.

2. The battery power source has been designed for the optional use of 3 volt lithium, 1.5 volts MA (LR03) Alcaline, 1.5 volt AA (LR05) Alcaline and 9 volt Alcaline.

3. There is a voltage control circuit that connects from the LED series to a controller and switch that cycle through each LED light each time the switch is pushed. The switch moves the completed current one LED per push.

4. A power supply for powering the series of LED lights each displaying a different color along the module's circuit to convey a separate visual communication for each color. The power supply has one or more loads which includes a resistor and power factor correction to provide the necessary operating voltage from a variable electrical power source. The power supply further includes a control circuit which is operated by both a toggle switch and a push button switch to drive the electrical current through each LED along the series of lights. Between each LED is a capacitor, diode and relay to move the current from one LED to the next LED until the current reaches the laser light. This is made possible by the storage of energy in the capacitors until required and accessed by pushing either the toggle switch or the push button switch to activate the LED series. The current can then be cycled through the series of LED lights again. Each LED light is connected by a stranded 14/3 12 gauge wire. The series of LED lights have a single pole double throw switch, mini relay, circuit breaker, controller and a push button switch and toggle switch for manual operation.

### FIELD OF THE INVENTION

This invention pertains generally to lighting enhancements and the visual augmentation that occurs when using Knuckle Lights with all firearms, including handguns, rifles and shotguns. The four different colors of the LED lights plus the one laser provide a professional and innovative law enforcement package that also improves safety.

### DESCRIPTION OF RELATED ART

There are currently flashlights, lasers and shrewd combinations of said apparatus which all technically work very well and are typically reliable. There is also a commercial market for gloves that protect hands from cold, heat, moisture, impact, bacterial, viral and abrasive threats.

What knuckle Lights provide that is new is the convenient combination of the LED lights and lasers that tacitly communicate poignant ideas and signals to law enforcement officers while actively getting as close to hands free operation as feasibly possible while under duress. Once activated, the focus of the police officer may remain primarily on the suspect whom sometimes display a course of behavior that causes a reasonable police officer or person believe justified in aiming his or her weapon at and lessen the distraction of having to firmly hold both a firearm and a flashlight. Knuckle Lights do require pushing either a pressure switch or a flip of a toggle switch to cause the LED lights and laser to activate one at a time with each single push of the switch. There are certainly good high quality flashlights on the consumer market, but the inventor and applicant of the present application has not observed a similar flashlight or illumination product that provided the detailed and satisfactory performance that Knuckle Lights provide. Knuckle lights are securely housed in a glove-like apparatus that combines the augmentation of visual acuity through illumination and insulation along with the range of protection for both hands from cold, heat, moisture, impact, bacterial, viral and abrasive threats.

### BRIEF DESCRIPTION OF THE VIEW OF THE DRAWING

FIG. 1 is a basic overall view of the Knuckle Light LED module of the present invention, with labels placed to provide a good understanding of the basic construction of the invention. The top of the invention as well as the left side of the invention are shown to provide ease of visual examination. The following numbers one (1) through twenty (20) provides the explanation of the numbers shown in the drawing.

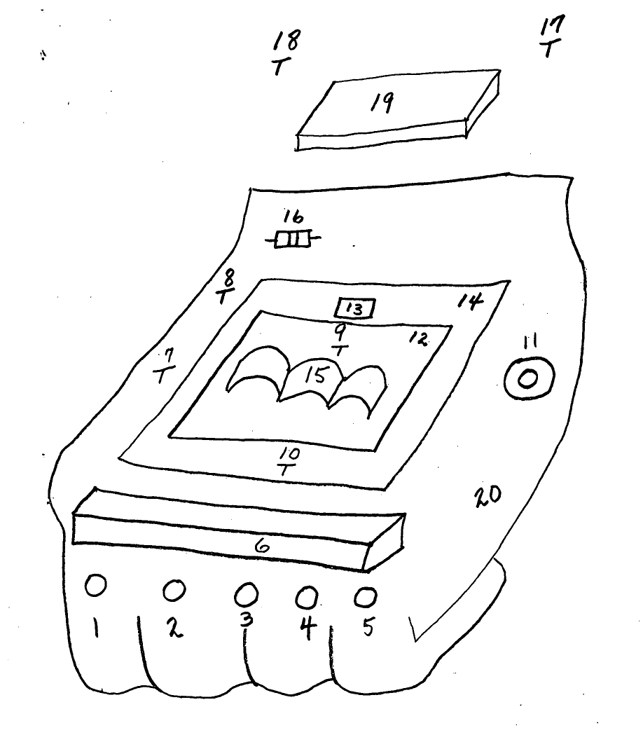

1) 5 mm Green LED
2) 5 mm Red LED
3) 5 mm Blue LED
4) 5 mm White LED
5) Laser
6) Clear LED Lens Cover and Bracket
7) Screw
8) Screw
9) Screw
10) Screw
11) LED Switch
12) Square Interior Liner
13) Fuse
14) Non-Conducive Plastic
15) Heat Sink
16) Resistor
17) Screw
18) Screw
19) Terminal Block (Strip)
20) Module LED Base (Glove)

What is claimed:

1. This invention enhances safety, visual imagery and dexterity for the user.

2. Although the primary target audience of consumers for this product is Law Enforcement and police officers, it can be used in a variety of professional fields and mechanical uses.

3. This invention can be used by electricians.

4. This invention can be used by plumbers.

5. This invention can be used by automotive mechanics.

6. This invention can be used by any individual needing to combine dexterity and focus of high quality lighting in a work space.

7. This invention is an ambidextrous product which can be worn and used by both left and right handed people.

8. This invention provides the ability for two separate Knuckle Light gloves for each hand to be worn at the same time.

9. Among the main safety features are that Knuckle Lights proportionally diminishes conditions that contribute to a dangerous encounter.

10. This invention eliminates the need for police officers to hold a flashlight and firearm simultaneously, while in the performance of law enforcement duties (which may include controlling, focusing on, apprehending, pursuing, questioning or arresting suspects [persons of interests]).

11. This invention provides law enforcement officers to ameliorate their training procedures to a higher safety level of productivity.

12. This invention can easily be operated with the offhand that does not have the firearm in the grasp. The term “firearm” is used to describe handguns, rifles shotguns and/or which ever single mechanical defense apparatus is selected to fulfill the law enforcement task.
